(19) United States
(12) Patent Application Publication
(10) Pub. No.: US 2015/0277781 A1
(43) Pub. Date: Oct. 1, 2015

(54) STORAGE DEVICE ADJUSTING DEVICE AND TIERED STORAGE DESIGNING METHOD

(71) Applicant: FUJITSU LIMITED, Kawasaki-shi (JP)

(72) Inventor: Tetsutaro MARUYAMA, Kawasaki (JP)

(21) Appl. No.: 14/643,547

(22) Filed: Mar. 10, 2015

(30) Foreign Application Priority Data
Mar. 31, 2014 (JP) 2014-074132

(51) Int. Cl. G06F 3/06

(52) U.S. Cl. CPC G06F 3/0611; G06F 3/0689; G06F 3/0665; G06F 2003/0692

(57) ABSTRACT

A memory stores plural pieces of information on a storage device including a first storage medium and a second storage medium. A processor obtains ratios of accesses to the respective storage mediums to a total number of accesses for the respective storage devices. The processor obtains a first number of requests that is a number of accesses capable of being processed in the respective storage devices within a prescribed time period. An interface preferentially reports information on the storage device having a relatively small difference between the first number of requests and the second number of requests.

### CROSS-REFERENCE TO RELATED APPLICATION

This application is based upon and claims the benefit of priority of the prior Japanese Patent Application No. 2014-074132, filed on Mar. 31, 2014, the entire contents of which are incorporated herein by reference.

### FIELD

The embodiments discussed herein are related to a tiered storage device.

### BACKGROUND

When a user purchases a new storage device, the user uses a capacity, performance, and a price of a storage device as determination criteria for purchase. When there are a plurality of storage devices that satisfy a capacity, performance, and a price of a storage that the user desires, the user selects one storage device from among a plurality of options. The user selects a storage device to be purchased from among, for example, a storage device having a maximum capacity, a storage device having the highest performance, a cheapest storage device and the like.

As a technology relating to a storage device, a tiered storage is known that combines storage devices that have different response performances to an I/O request (see, for example, Patent Document 1).

As a technology for presenting a recommended system device to a user, a technology is known for determining a cheapest computer system from among computer systems having prescribed processing performance (see, for example, Patent Document 2).

As a technology for representing a recommended system device to a user, a technology is known for proposing a system device that satisfies a prescribed error range from a given performance requirement and a given price requirement (see, for example, Patent Document 3).

Patent document 1: Japanese Laid-open Patent Publication No. 2013-164822

Patent document 2: Japanese Laid-open Patent Publication No. 2004-30292

Patent document 3: Japanese Laid-open Patent Publication No. 2002-183416

### SUMMARY

A memory stores plural pieces of information on a storage device that includes a first storage medium and a second storage medium capable of higher-speed access than the first storage medium. A processor obtains ratios of accesses to the respective storage mediums to a total number of accesses for the respective storage devices, using a function indicating a relationship between pieces of data stored in the respective storage mediums and access frequencies to the respective pieces of data, when pieces of data having high access frequencies have been stored preferentially in the second storage medium. The processor obtains a first number of requests that is a number of accesses capable of being processed in the respective storage devices within a prescribed time period on the basis of a number of requests capable of accessing the first storage medium within the prescribed time period and the ratio for the first storage medium. The processor obtains a second number of requests that is a number of accesses capable of being processed in the respective storage devices within the prescribed time period on the basis of a number of requests capable of accessing the second storage medium within the prescribed time period and the ratio for the second storage medium. An interface preferentially reports information on the storage device that has a relatively small difference between the first number of requests and the second number of requests.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a system configuration according to an embodiment.

FIG. 2 illustrates an example of a hardware configuration of a support device.

FIG. 3 illustrates an example of a process of a tiered storage according to the embodiment (no. 1).

FIG. 4 illustrates an example of a process of a tiered storage according to the embodiment (no. 2).

FIG. 5 illustrates an example of a process of a support device according to the embodiment.

FIG. 6 illustrates an example of a method for calculating the assumed number of processes performed by the entirety of a storage device.

FIG. 7 illustrates an example of output of tiered storage information that a support device recommends.

FIG. 8 is a flowchart explaining an example of a process of a support device.

FIG. 9 is a flowchart explaining an example of a method for selecting a recommended tiered storage according to the embodiment.

### DESCRIPTION OF EMBODIMENTS

When a user purchases a storage device, the user refers to a parameter sheet that is a list of performances of storage devices. The user selects storage devices that satisfy requirements that the user desires on the parameter sheet, and selects one of the storage devices. However, the performances of the storage devices described on the parameter sheet are performances that brand-new storage devices can exhibit. Accordingly, when the user actually commences using the storage device and stores data, the storage device may fail to exhibit the performance as described on the parameter sheet. As a result, the storage device that the user is actually using may fail to satisfy the requirements that the user has desired.

It is an object in one aspect of the embodiments to present, to a user, a storage device that is likely to achieve a processing speed that the user desires during operation of the storage device.

The embodiments are described below in detail with reference to the drawings.

A support device according to the embodiment proposes a recommended storage device to a user when the user purchases a storage device. In the embodiment, the support device is used as an example of a storage device that proposes a tiered storage that is mounted with HDDs (Hard Disk Drives) and SSDs (Solid State Drives) while being combined. The tiered storage is a device that includes two or three tiers having different performances, such as an SSD, which serves as a high-performance tier, Online SAS (Serial Attached SCSI), which serves as a medium-performance tier, or Nearline SAS, which serves as a low-performance tier. HDDs are used for Online SAS and Nearline SAS. Online SAS is a storage area that needs continuous operation and responsiveness. Nearline SAS is a storage area that stores data having an access frequency that is lower than that of data stored in Online SAS, and that does not need a performance that is higher than that of Online SAS.

The tiered storage realizes a high-performance storage device by storing data having a high access frequency in a storage area that serves as a high-performance tier. Simultaneously, the tiered storage can realize a storage device having a large capacity by storing data having a low access frequency in a low-speed, low-cost, and large-capacity storage area that serves as a low-performance tier. However, as an amount of data stored in each of the storage devices increases, a response of the tiered storage may be reduced. As an example, when an amount of data stored in a high-performance tier increases and data having a high access frequency is stored also in a medium-performance tier, an access frequency of the medium-performance tier increases, and the response of the tiered storage is reduced compared with a response at the time of purchase. Similarly, when an amount of data stored in the medium-performance tier increases and data having a medium-level access frequency is stored also in the low-performance tier, an access frequency of the low-performance tier increases, and the response of the tiered storage is reduced compared with a response at the time of purchase.

The support device according to the embodiment assumes a tiered storage that has stored data in all of the storage areas, and recommends, to a user, a storage device that is likely to exhibit a performance desired by the user even during operation from among storage devices that satisfy requirements desired by the user.

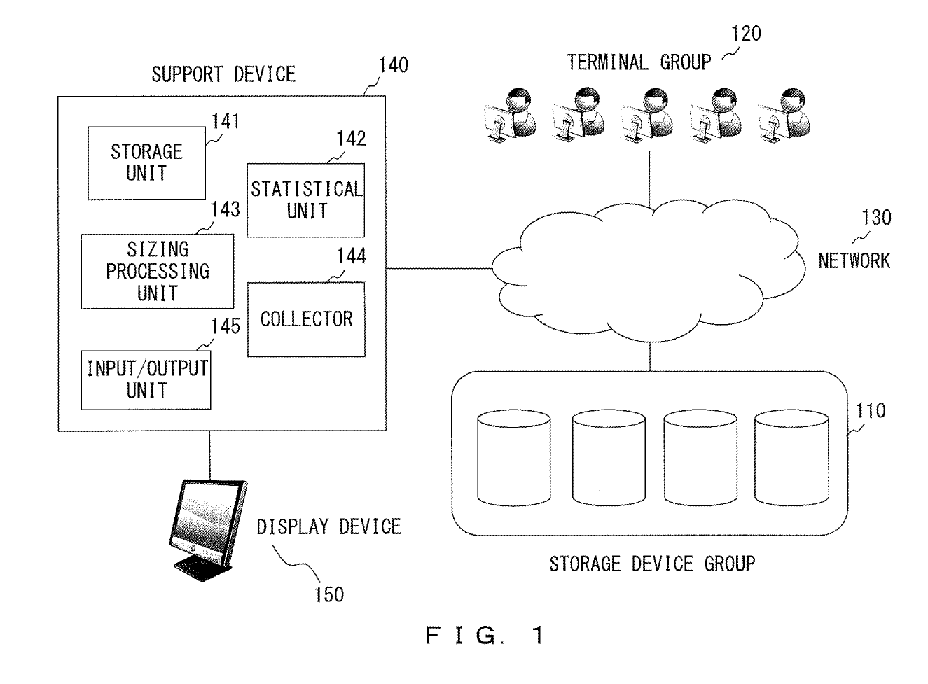

FIG. 1 illustrates an example of a system configuration according to the embodiment. The system according to the embodiment includes a storage device group 110, a terminal group 120, a network 130, a support device 140, and a display device 150. The storage device group 110 includes a plurality of storage devices that are operating in the system. The terminal group 120 is an interface that provides a user with the storage device group 110. The storage device group 110 and the terminal group 120 are connected via the network 130. When a user is considering to newly purchase a storage device, the support device 140 performs sizing a recommended storage device, and presents the recommended storage device to the user via the display device 150.

A process performed by the support device 140 is described below.

(1) A collector 144 periodically collects I/O statistical information of an I/O instruction that flows in a network 130. The statistical information includes a time at which the I/O instruction is generated, a size of the I/O instruction, and information as to whether the I/O instruction is a read instruction or a write instruction.

(2) A statistical unit 142 calculates the number of processed I/O instructions per second (IOPS: Input Output Per Second), an average data size of I/O, an average read rate or the like on the basis of the I/O statistical information. The statistical unit 142 has a storage unit 141 store use state information of a storage device in a system being used, which is data obtained by the calculation.

(3) The storage unit 141 stores pieces of the use state information of the storage devices in the system by repeating processes (1) and (2).

(4) An input/output unit 145 obtains, from the display device 150, requirement information such as a capacity, performance, or a price of a storage that a user desires.

(5) A sizing processing unit 143 obtains, from the storage unit 141, the pieces of use state information of the storage devices in the system being used.

(6) The sizing processing unit 143 obtains, from the storage unit 141, plural pieces of specification information of tiered storages. The specification information of the tiered storage includes, for example, the type of disk, RAID, a response time defined by a specification, or the like for respective tiers of SSD, Online SAS, and Nearline SAS.

(7) The sizing processing unit 143 extracts a storage device that satisfies requirements such as a capacity, performance, or a price of a storage that a user desires on the basis of the obtained plural pieces of specification information of the tiered storages. The sizing processing unit 143 further extracts a storage device that has performance capable of processing the use state information of the storage device.

(8) The sizing processing unit 143 performs the following processes when there are a plurality of storage devices that satisfy the requirements that the user desires.

(8.1) The sizing processing unit 143 refers to the specification information of the tiered storage obtained in process (7) so as to obtain the number of instructions (IOPS) that a medium-performance tier and a low-performance tier in each of the storage devices that satisfy the requirements that the user desires can process within a prescribed time period. The number of instructions (IOPS) that each of the tiers can process within a prescribed time period is the number of I/O instructions (the number of access requests) that can be processed within an allowable response time period range for each of the tiers that a manufacturer has specified. Hereinafter, the number of instructions that the medium-performance tier can process within the allowable response time period range for each of the tiers that the manufacturer has specified is referred to as a “maximum medium-performance tier processing performance”. Similarly, the number of instructions that the low-performance tier can process within the allowable response time period range for each of the tiers that the manufacturer has specified is referred to as a “maximum low-performance tier processing performance”.

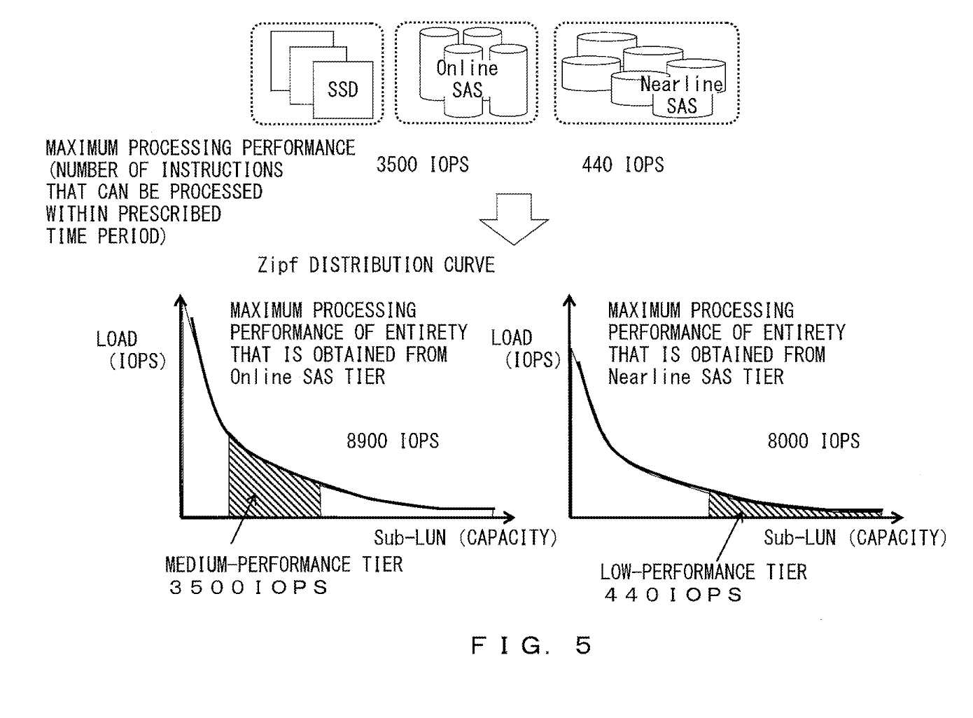

(8.2) The sizing processing unit 143 generates a load distribution of the entirety of the tiered storage on the basis of the maximum medium-performance tier processing performance. The sizing processing unit 143 calculates the assumed number of processes that the entirety of the storage is assumed to be capable of processing within a prescribed time period on the basis of the load distribution of the entirety of the tiered storage (described later in detail with reference to FIG. 5). The sizing processing unit 143 has stored a calculation method using a distribution model of access frequencies to respective blocks when a storage area in the storage device is divided into the blocks each having a prescribed size. In a tiered storage device, data to be processed in the medium-performance tier is data having a relatively high access frequency in data that remains after assigning a high-performance tier in the tiered storage to a process on data having a high access frequency in the distribution model. Therefore, the sizing processing unit 143 calculates a distribution model in which an access frequency of data assigned to the medium-performance tier matches a maximum medium-performance tier processing performance in the tiered storage when it is assumed that data having a higher access frequency is processed by a storage having a higher performance. The sizing processing unit 143 calculates the assumed number of processes that are processed in the entirety of the tiered storage within the prescribed time period, assuming that the obtained distribution model is a load distribution that can be processed in the tiered storage.

(8.3) The sizing processing unit 143 generates a load distribution of the entirety of the tiered storage on the basis of the maximum low-performance tier processing performance. The sizing processing unit 143 calculates the assumed number of processes that the entirety of the storage can process within the prescribed time period on the basis of the load distribution of the entirety of the tiered storage (described later in detail with reference to FIG. 5).

(8.4) The sizing processing unit 143 obtains a ratio of the assumed number of processes of the entirety of the storage device assumed from the maximum medium-performance tier processing performance to the assumed number of processes of the entirety of the storage device assumed from the maximum low-performance tier processing performance.

(8.5) The sizing processing unit 143 uses Log for the ratio calculated in process (8.4). The sizing processing unit 143 preferentially selects a storage device for which a result value of a ratio substituted in Log is close to zero as a tiered storage to be recommended to the user.

(9) The sizing processing unit 143 reports information of the selected tiered storage to the input/output unit 145.

(10) The input/output unit 145 presents information of the tiered storage to be recommended to the user via the display device 150.

The support device 140 repeatedly performs processes (1)-(3) independently of processes (4)-(10). Process (4) and the processes that follow are performed in response to input of requirement information such as a capacity, performance, a price or the like of a storage that a user desires. The support device 140 according to the embodiment can perform processes (4)-(10) by a user inputting a use state of a storage device in a system without performing processes (1)-(3). Accordingly, the support device 140 does not need to be connected to the network 130. A user inputs information indicating a use state of a storage device to the support device 140 using the display device 150. In process (10), the tiered storage extracted in process (7) may be displayed in addition to the tiered storage selected in process (8.5).

The support device according to the embodiment assumes a tiered storage in which data has been stored in all of the storage areas, and recommends to a user a storage device that is likely to exhibit performance that a user desires even during operation from among storage devices that satisfy requirements that the user desires.

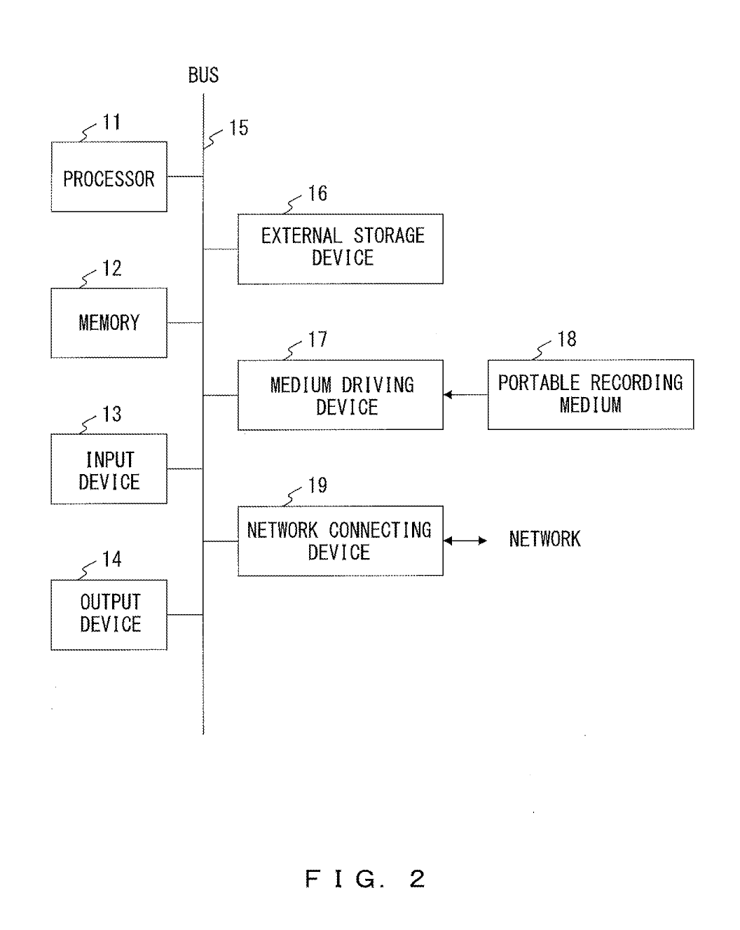

FIG. 2 illustrates an example of a hardware configuration of the support device. The support device 140 includes a processor 11, a memory 12, a bus 15, an external storage device 16, and a network connecting device 19. As an option, the support device 140 may further include an input device 13, an output device 14, and a medium driving device 17. The support device 140 is realized by, for example, a computer or the like in some cases. The input device 13 and the output device 14 are realized by the display device 150 in the embodiment.

The processor 11 is a Central Processing Unit (CPU). The processor 11 can operate as the statistical unit 142, the sizing processing unit 143, the collector 144, and the input/output unit 145. Note that the processor 11 can execute a program that has been stored in the external storage device 16, for example. The memory 12 operates as the storage unit 141. The external storage device 16 may be the storage unit 141. Further, the memory 12 stores data obtained by operation of the processor 11 or data used for a process performed by the processor 11 as needed. The network connecting device 19 is used for communication with other devices.

The input device 13 is realized as, for example, a button, a keyboard, a mouse or the like, and the output device 14 is realized as a display or the like. The bus 15 connects the processor 11, the memory 12, the input device 13, the output device 14, the external storage device 16, the medium driving device 17, and the network connecting device 19 so as to receive/transmit data from/to each other. The external storage device 16 stores programs, data or the like, and provides stored information to the processor 11 or the like as needed. The medium driving device 17 can output data in the memory 12 or the external storage device 16 to a portable storage medium 18, and can read programs, data or the like from the portable storage medium 18. Here, the portable storage medium 18 can be an arbitrary portable storage medium including a flexible disk, a Magnet-Optical (MO) disk, a Compact Disc Recordable (CD-R), and a Digital Versatile Disk Recordable (DVD-R).

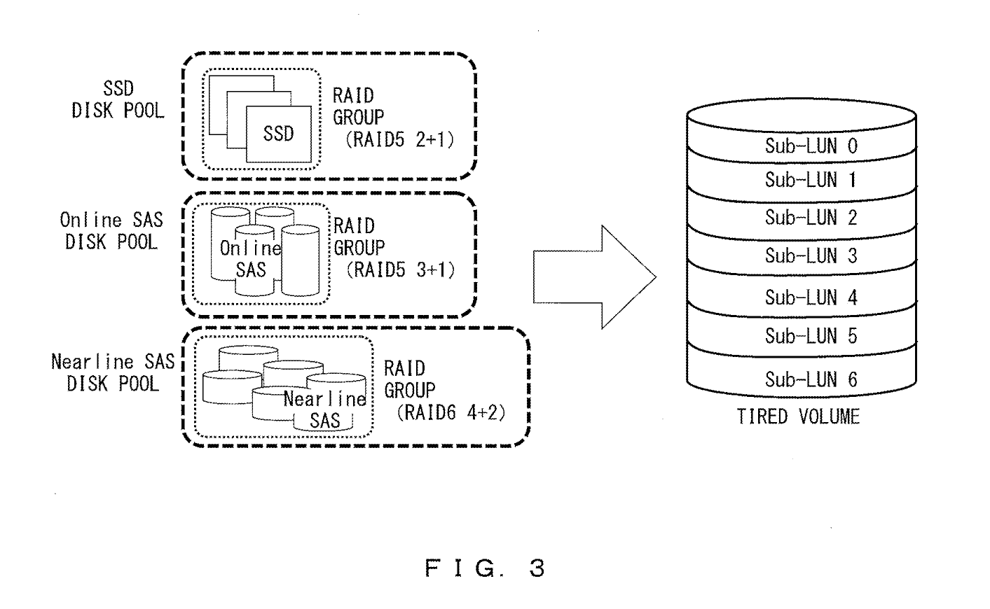

FIG. 3 illustrates an example of a process of a tiered storage according to the embodiment (no. 1). SSDs and HDDs in the tiered storage configure RAID (Redundant Array of Independent Disks). In the tiered storage illustrated in FIG. 3, a high-performance tier are mounted with SSDs of RAID5 (2+1). In the tiered storage illustrated in FIG. 3, a medium-performance tier are mounted with HDDs of RAID5 (3+1) as Online SAS. In the tiered storage illustrated in FIG. 3, a low-performance tier is mounted with HDDs of RAID6 (4+2) as Nearline SAS.

The tiered storage provides a user with a tiered volume that is obtained by virtually integrating a tier of SSDs and tiers of HDDs as storage areas. The tiered volume is managed in units of plural pieces of data referred to as “Sub-LUN”. In the tiered storage, pieces of data are arranged in units of Sub-LUN in the storage areas of the high-performance tier through the low-performance tier in accordance with access frequencies of pieces of data stored in respective Sub-LUNs.

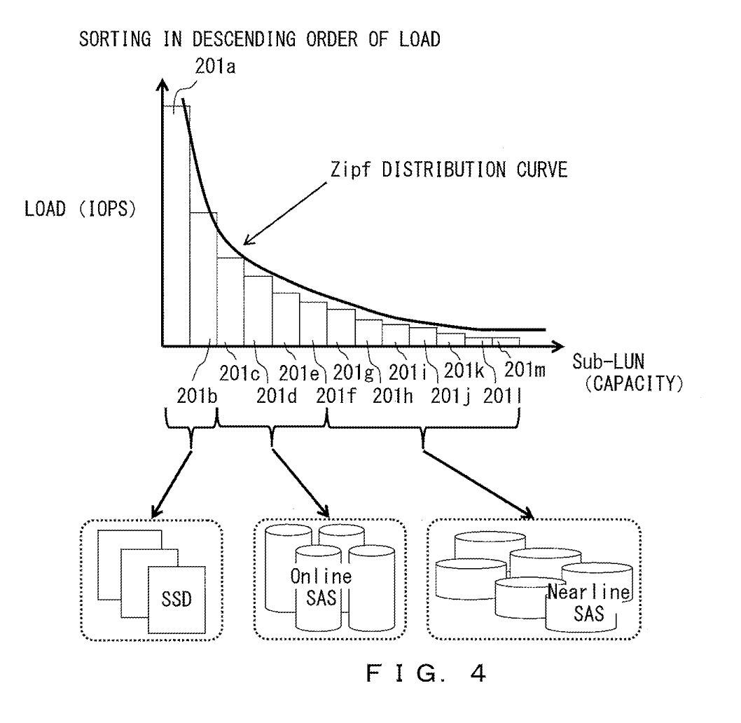

FIG. 4 illustrates an example of a process of a tiered storage according to the embodiment (no. 2). Bar graphs respectively correspond to the Sub-LUNs in FIG. 3, and a vertical axis expresses an access frequency (IOPS) to data stored in Sub-LUN, and a horizontal axis expresses a capacity of Sub-LUN. In the bar graphs in FIG. 4, assumed values are expressed so as to be arranged in descending order of an assumed value of an access frequency to data stored in each of the Sub-LUNs 201a-201m. In the example of FIG. 4, it is assumed that access frequencies to pieces of data in the respective Sub-LUNs 201 have a fixed deviation. Because the access frequencies to the pieces of data in the respective Sub-LUNs 201 have a deviation, in the tiered storage, Sub-LUNs that store data having a high access frequency are stored in the high-performance tier, and Sub-LUNs that store data having a low access frequency are stored in the low-performance tier. As an example, in the tiered storage, Sub-LUNs 201a and 201b, which have high access frequencies and high loads, are stored in the storage area of the high-performance tier such as SSDs. In the tiered storage, Sub-LUNs 201c-201f, which have lower access frequencies than those of Sub-LUNs 201a and 201b, are stored in the storage area of the medium-performance tier such as Online SAS. In the tiered storage, Sub-LUNs 201g-201m, which have lower access frequencies than those of Sub-LUNs 201c-201f, are stored in the storage area of the low-performance tier such as Nearline SAS. Note that an access frequency to data stored in each of the Sub-LUNs may be paraphrased to a load on each of the Sub-LUNs.

In the embodiment, the support device 140 generates a load distribution of the entirety of the tiered storage using loads on Sub-LUNs in the tiered storage. As an example, the support device 140 uses the Zipf distribution illustrated in FIG. 4 for the load distribution. The Zipf distribution is one of probability distributions that express deviations of access frequencies. The Zipf distribution is a rule of thumb whereby a ratio of an element having the k-th highest appearance frequency to the entirety is proportional to 1/k. Accordingly, in the support device 140, it is assumed that data has been written to all of the storage areas in the tiered storage and that loads according to the Zipf distribution are applied to the respective Sub-LUNs.

In the example of FIG. 4, a load on the high-performance tier can be calculated by adding loads on Sub-LUNs 201a and 201b. Therefore, the total area of Sub-LUNs 201a and 201b is assumed to be the load on the high-performance tier. Then, a load on the medium-performance tier can be calculated by adding areas of Sub-LUNs 201c-201f. Similarly, a load on the low-performance tier can be calculated by adding areas of Sub-LUNs 201g-201m. Further, a load assumed to be applied to the entirety of the tiered storage can be calculated by adding areas of Sub-LUNs 201a-201m.

FIG. 5 illustrates an example of a process of the support device according to the embodiment. The support device 140 generates the Zipf distribution illustrated in FIG. 4, and performs processes (8.1)-(8.5). The sizing processing unit 143 obtains the number of instructions that the medium-performance tier and the low-performance tier in each of the storage devices that satisfy requirements that a user desires can process within a prescribed time period (maximum processing performance) from the specification information of the tiered storage. In the example of FIG. 5, a maximum medium-performance tier processing performance of a storage device is 3500 IOPS. A maximum low-performance tier processing performance of the same storage device is 440 IOPS.

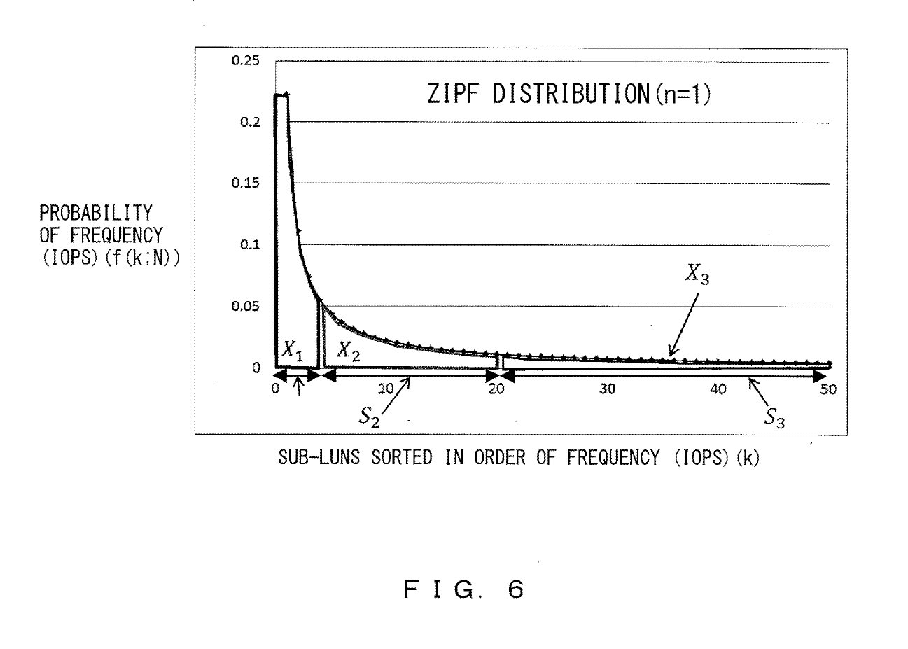

The support device 140 sets 3500 IOPS, which is the maximum medium-performance tier processing performance, to be a load on the medium-performance tier. The support device 140 obtains information on capacities of the high-performance tier through the low-performance tier from the storage unit, and calculates a range of the medium-performance tier on a horizontal axis of a Zipf distribution chart. The support device 140 integrates loads on Sub-LUNs within the range of the medium-performance tier on the horizontal axis in the Zipf distribution chart, and generates a Zipf distribution in which an area that indicates the load on the medium-performance tier reaches 3500 IOPS. The support device 140 calculates the assumed number of processes that the entirety of the storage is assumed to perform within a prescribed time period. As a result, the assumed number of processes in the entirety of the storage device based on the maximum medium-performance tier processing performance is 8900 IOPS. A calculation method is described later with reference to FIG. 6.

Then, 440 IOPS, which is the maximum low-performance tier processing performance, is set to be a load on the low-performance tier. The support device 140 obtains information on capacities of the high-performance tier through the low-performance tier from the storage unit, and calculates a range of the low-performance tier on the horizontal axis of the Zipf distribution chart. The support device 140 integrates loads on Sub-LUNs within the range of the low-performance tier on the horizontal axis of the Zipf distribution chart, and generates a Zipf distribution in which an area indicating the load on the low-performance tier reaches 440 IOPS. The support device 140 calculates the assumed number of processes that the entirety of the storage is assumed to perform within a prescribed time period on the basis of the generated Zipf distribution. As a result, the assumed number of processes of the entirety of the storage device based on the maximum low-performance tier processing performance is 8000 IOPS. A calculation method is described later with reference to FIG. 6. As a result of the calculations above, two types of assumed number of processes are calculated on the basis of one piece of tiered storage information.

When the entirety of the storage device is made to perform processes exceeding 8000 IOPS, which is the assumed number of processes of the entirety of the storage device that has been obtained from a distribution of the number of accesses calculated on the basis of the maximum low-performance tier processing performance, the low-performance tier reaches the processing limit before other tiers do. When this happens, the medium-performance tier has an available capacity for the number of instructions that the medium-performance tier can process within a prescribed time period.

The support device according to the embodiment recommends, to a user, a storage device for which the assumed number of processes of the entirety of the storage device based on the low-performance tier is close to the assumed number of processes of the entirety of the storage device based on the medium-performance tier. The recommended storage device is a storage device in which the low-performance tier hardly reaches the limit for the number of instructions that the low-performance tier can process within a prescribed time period, and that is reduced in the price by lowing performance of the medium-performance tier that has an available capacity.

FIG. 6 illustrates an example of a method for calculating the assumed number of processes performed by the entirety of the storage device. In the Zipf distribution of FIG. 6, a vertical axis expresses a probability of an access frequency, and a horizontal axis expresses Sub-LUNs that have been sorted in descending order of an access frequency. The horizontal axis of the Zipf distribution of FIG. 6 indicates that the number of Sub-LUNs is 50 (N=50). From among N Sub-LUNs, the number of Sub-LUNs assigned to the high-performance tier is expressed as S₁. The number of Sub-LUNs assigned to the medium-performance tier is expressed as S₂. The number of Sub-LUNs assigned to the low-performance tier is expressed as S₃. Information on the Sub-LUN such as S₁ to S₃ has been stored in the storage unit 141 in accordance with each of the tiered storages.

In the Zipf distribution, a probability of an access frequency of Sub-LUN having the k-th greatest access frequency from among N Sub-LUNs is expressed as f(k; N). f(k; N) is expressed by expression (1). In addition, the Zipf distribution has a precondition expressed by expression (2).

$$\begin{matrix}f ( k ; N ) = \frac{\frac{1}{k}}{{\sum }_{n = 1}^{N} \frac{1}{n}} & ( 1 ) \\ {\sum }_{k = 1}^{N} f ( k ; N ) = 1 & ( 2 )\end{matrix}$$

Assuming that a load (IOPS) on the entirety of the tiered storage is X, a load (IOPS) on Sub-LUN having the k-th greatest access frequency can be obtained by Xf(k; N). Note that the load X on the entirety of the tiered storage is the sum of a load on the high-performance tier X₁, a load on the medium-performance tier X₂, and a load on the low-performance tier X₃. Therefore, X, which is the load (IOPS) on the entirety of the tiered storage, is expressed by an area surrounded by a Zipf distribution curve, and a horizontal axis (a Sub-LUN range) and a vertical axis (probability) of the Zipf distribution chart.

In the Zipf distribution chart of FIG. 6, the load (IOPS) on the high-performance tier can be calculated by integrating the first to S₁-th IOPSs. Similarly, the load on the medium-performance tier can be calculated by integrating the (S₁+1)th to (S₁+S₂)th IOPSs. The load on the low-performance tier can be calculated by integrating the (S₁+S₂+1)th to (S₁+S₂+S₃)th IOPSs.

In order to speed up calculation of processing performance of each of the tiers, an Euler expression is used. The Euler expression is expressed by expression 3. γ in the Euler expression is the Euler-Mascheroni constant.

$${\sum }_{k = 1}^{N} \frac{1}{k} = log N + γ + {ɛ}_{n} \qquad ( 3 )$$

Note that ε is 0 when a value of n becomes greater. Therefore, when N has a great value, ε does not need to be counted in calculation.

Expressions 4-7 are halfway expressions for deforming expression 1 using the Euler expression. Z₁, which is a ratio of the load on the high-performance tier in the tiered storage, is calculated using expressions 1-3, and is expressed by expression 4. Z₂, which is a ratio of the load on the medium-performance tier in the tiered storage, is expressed by expression 5. Z₃, which is a ratio of the load on the low-performance tier in the tiered storage, is expressed by expression 6. A ratio of the loads on the high-performance tier and the medium-performance tier in the tiered storage is expressed as Z₁₂ (expression 7).

$$\begin{matrix}{Z}_{1} = {\sum }_{k = 1}^{{S}_{1}} f ( k ; N ) = {\sum }_{k = 1}^{{S}_{1}} \frac{\frac{1}{k}}{{\sum }_{n = 1}^{N} \frac{1}{n}} = \frac{{\sum }_{k = 1}^{{S}_{1}} \frac{1}{k}}{{\sum }_{n = 1}^{N} \frac{1}{n}} = \frac{ln {S}_{1} + γ}{ln N + γ} & ( 4 ) \\ {Z}_{2} = {\sum }_{k = {S}_{1} + 1}^{{S}_{1} + {S}_{2}} f ( k ; N ) = {\sum }_{k = 1}^{{S}_{1} + {S}_{2}} f ( k ; N ) - {\sum }_{k = 1}^{{S}_{1}} f ( k ; N ) = {\sum }_{k = 1}^{{S}_{1} {S}_{2}} f ( k ; N ) - {Z}_{1} & ( 5 ) \\ {Z}_{3} = {\sum }_{k = {S}_{1} + {S}_{2} + 1}^{N} f ( k ; N ) = {\sum }_{k = 1}^{N} f ( k ; N ) - {\sum }_{k = 1}^{{S}_{1} + {S}_{2}} f ( k ; N ) = 1 - {\sum }_{k = 1}^{{S}_{1} + {S}_{2}} f ( k ; N ) & ( 6 ) \\ {Z}_{12} = {\sum }_{k = 1}^{{S}_{1} + {S}_{2}} f ( k ; N ) = {\sum }_{k = 1}^{{S}_{1} + {S}_{2}} \frac{\frac{1}{k}}{{\sum }_{n = 1}^{N} \frac{1}{n}} = \frac{{\sum }_{k = 1}^{{S}_{1} + {S}_{2}} \frac{1}{k}}{{\sum }_{n = 1}^{N} \frac{1}{n}} = \frac{ln ( {S}_{1} + {S}_{2} ) + γ}{ln N + γ} & ( 7 )\end{matrix}$$

Accordingly, expressions 4-7 are arranged as the following (expressions 8-11).

$$\begin{matrix}{Z}_{1} = \frac{ln {S}_{1} + γ}{ln N + γ} & ( 8 ) \\ {Z}_{12} = \frac{ln ( {S}_{1} + {S}_{2} ) + γ}{ln N + γ} & ( 9 ) \\ {Z}_{2} = {Z}_{12} - {Z}_{1} & ( 10 ) \\ {Z}_{3} = 1 - {Z}_{12} & ( 11 )\end{matrix}$$

Calculation results of expressions 8-11 are ratios of loads on the respective tiers. Accordingly, when the load on the entirety of the tiered storages is calculated from the load on the medium-performance tier as illustrated in FIG. 5, the support device 140 first obtains information on N, which the number of Sub-LUNs in the entirety of the tiered storage, and information on S₁, which is the number of Sub-LUNs in the high-performance tier. The support device 140 calculates a value of Z₁ from values of N and S₁, using expression 8. The support device 140 obtains information on S₂, which is the number of Sub-LUNs in the medium-performance tier, and calculates a value of Z₁₂ using expression 9. The support device 140 performs calculation expressed by expression 10 using calculation results of expressions 8 and 9. In addition, the support device 140 performs calculation expressed by expression 11 using a calculation result of expression 9. As a result, the support device 140 can calculate the ratios of loads on the respective tiers, and can calculate the load on the entirety of the tiered storage from, for example, a value of the load on the medium-performance tier.

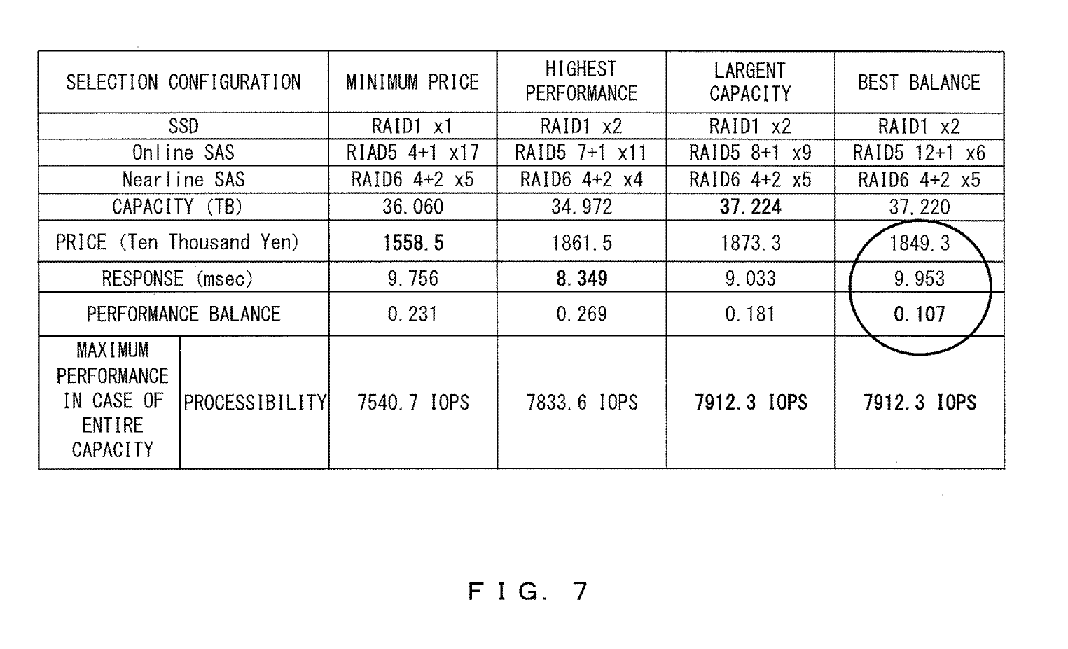

FIG. 7 illustrates an example of output of tiered storage information that a support device recommends. The support device 140 outputs recommended tiered storage information in the form of a parameter sheet, for example. The parameter sheet includes pieces of information on an SSD of the high-performance tier, Online SAS of the medium-performance tier, and NearLine SAS of the low-performance tier, and pieces of information on a capacity, a price, a response, a performance balance, and processing performance of a tiered storage when all capacities has been used. The pieces of information on the SSD of the high-performance tier, the Online SAS of the medium-performance tier, and the NearLine SAS of the low-performance tier includes information on a combination of RAIDs. The performance balance is a result value of a ratio substituted in Log that has been calculated in process (8.5). A tiered storage that has a performance balance closer to 0 is a storage device in which the low-performance tier hardly reaches the limit for the number of instructions that the low-performance tier can process within a prescribed time period, and that is reduced in the price by lowing performance of the medium-performance tier that has an available capacity. The information on the processing performance of the tiered storage when all capacities has been used is a processing performance that indicates the number of instructions that the entirety of the tiered storage can process within a prescribed time period.

The support device 140 extracts information on tiered storages that satisfy requirements that a user desires from information on all of the tiered storages that has been stored in the storage unit 141. The support device 140 recommends a tiered storage that has a performance balance that is close to 0 from among the tiered storages that satisfy the requirements that the user desires. A storage device is recommended to the user by emphasizing the recommended storage device by, for example, displaying characters in bold text in a parameter sheet. In the example of FIG. 7, a performance balance of an inexpensive tiered storage is 0.231, a performance balance of a tiered storage having a quick response is 0.269, and a performance balance of a tiered storage having a large capacity is 0.181. Accordingly, the support device 140 selects a tiered storage that has a performance balance of 0.171, which is close to 0, as a storage device that is recommended preferentially.

The support device 140 may output all of the tiered storages that satisfy requirements that a user desires. In the parameter sheet of FIG. 7, the support device 140 presents, to a user, tiered storages that respectively have a low price, a quick response, a large capacity, and a satisfactory performance balance. The support device 140 may present a tiered storage that has a satisfactory performance balance as a recommended tiered storage without including information on the other tiered storages. Further, information presented to a user is not limited to the contents on the parameter sheet.

The support device according to the embodiment recommends, to a user, a storage device for which the assumed number of processes of the entirety of the storage device based on the low-performance tier is close to the assumed number of processes of the entirety of storage device based on the medium-performance tier. The recommended storage device is a storage device in which the low-performance tier hardly reaches the limit for the number of instructions that the low-performance tier can process within a prescribed time period, and that is reduced in the price by lowing performance of the medium-performance tier that has an available capacity.

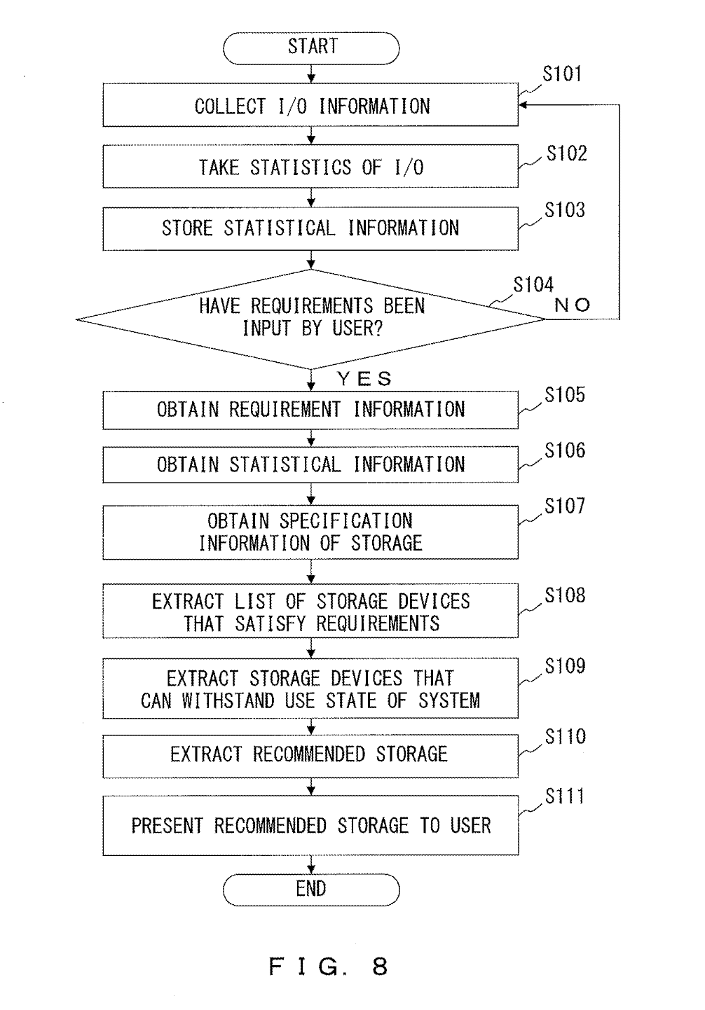

FIG. 8 is a flowchart explaining an example of a process of the support device. The collector 144 collects I/O statistical information of an I/O instruction that flows in the network 130 (step S101). The statistical unit 142 takes statistics of a use state of a storage device in a system from the collected I/O statistical information (step S102). The storage unit 141 stores the statistics of the use state of the storage device in the system (step S103). The input/output unit 145 determines whether input of requirement information such as a capacity, performance, a price or the like of a storage that a user desires has been performed in the display device 150 (step S104). When input of the requirement information of the storage that a user desires has not been performed, the support device repeats the process of step S101 and the processes that follow.

The input/output unit 145 obtains the requirement information from the display device 150 (“YES” in step S105 and step S104). The sizing processing unit 143 obtains use state information of the storage device from the storage unit 141 (step S106). The sizing processing unit 143 obtains pieces of specification information of tiered storages from the storage unit 141 (step S107). The sizing processing unit 143 extracts, from the obtained pieces of specification information of tiered storages, storage devices that satisfy requirements of a storage that a user desires, such as a capacity, performance, or a price (step S108). The sizing processing unit 143 extracts storage devices that have performance capable of processing the use state information of the storage device (step S109). The sizing processing unit 143 extracts a recommended storage device that has little response deterioration even when use is actually commenced and that is reduced in the price (step S110). The sizing processing unit 143 transmits information on the recommended storage device to the display device 150, and presents the information to the user (step S111).

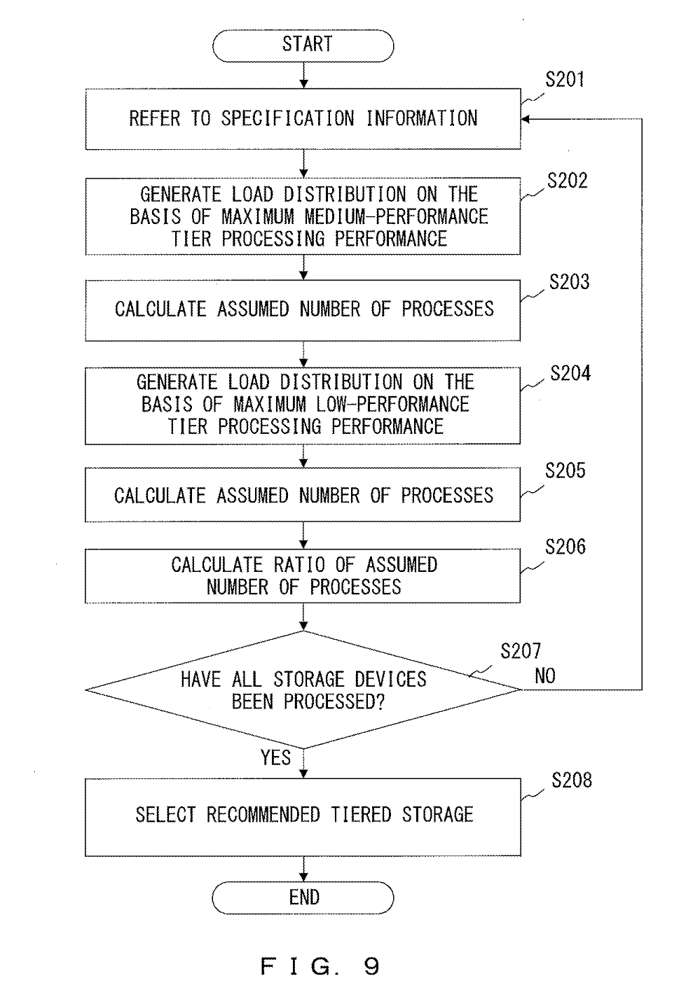

FIG. 9 is a flowchart explaining an example of a method for selecting a recommended tiered storage according to the embodiment. With reference to the flowchart of FIG. 9, step S110 of FIG. 8 is described in detail. The sizing processing unit 143 refers to the specification information of the tiered storage so as to obtain the number of instructions (IOPS) that the medium-performance tier and the low-performance tier of each of the storage devices that satisfy the requirements that the user desires can process within a prescribed time period (step S201). The sizing processing unit 143 generates a load distribution of the entirety of the tiered storage on the basis of a maximum medium-performance tier processing performance (step S202). The sizing processing unit 143 calculates the assumed number of processes that the entirety of the storage is assumed to process within a prescribed time period on the basis of the load distribution of the entirety of the tiered storage (step S203). The sizing processing unit 143 generates a load distribution of the entirety of the tiered storage on the basis of a maximum low-performance tier processing performance (step S204). The sizing processing unit 143 calculates the assumed number of processes that the entirety of the storage is assumed to process within a prescribed time period on the basis of the load distribution of the entirety of the tiered storage (step S205).

The sizing processing unit 143 obtains a ratio of the assumed number of processes of the entirety of the storage device that is assumed from the maximum medium-performance tier processing performance to the assumed number of processes of the entirety of the storage device that is assumed from the maximum low-performance tier processing performance (step S206). The sizing processing unit 143 determines whether all of the storage devices that satisfy the requirements that the user desires have been processed (step S207). When the processes of S201-S206 have not been performed on all of the storage devices that satisfy the requirements that the user desires, the process of S201 and the processes that follow are repeated. The ratio calculated in S206 is substituted in Log, and a storage device for which a result value is close to 0 is selected preferentially as a tiered storage to be recommended to the user (“YES” in step S208 and step S207).

The support device according to the embodiment recommends, to a user, a storage device for which the assumed number of processes of the entirety of a storage device based on a low-performance tier is close to the assumed number of processes of the entirety of the storage device based on a medium-performance tier. The recommended storage device is a storage device in which the low-performance tier hardly reaches the limit for the number of instructions that the low-performance tier can process within a prescribed time period, and that is reduced in the price by lowing performance of the medium-performance tier that has an available capacity.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage device adjusting device comprising:
a memory configured to store plural pieces of information on a storage device that includes a first storage medium and a second storage medium capable of higher-speed access than the first storage medium;
a processor configured to execute a process including:
obtaining ratios of accesses to the respective storage mediums to a total number of accesses for the respective storage devices, using a function indicating a relationship between pieces of data stored in the respective storage mediums and access frequencies to the respective pieces of data, when pieces of data having high access frequencies have been stored preferentially in the second storage medium;
obtaining a first number of requests that is a number of accesses capable of being processed in the respective storage devices within a prescribed time period on the basis of a number of requests capable of accessing the first storage medium within the prescribed time period and the ratio for the first storage medium; and
obtaining a second number of requests that is a number of accesses capable of being processed in the respective storage devices within the prescribed time period on the basis of a number of requests capable of accessing the second storage medium within the prescribed time period and the ratio for the second storage medium; and
an interface configured to preferentially report information on the storage device that has a relatively small difference between the first number of requests and the second number of requests.

2. The storage device adjusting device according to claim 1, wherein
the function expresses that magnitudes of the access frequencies to the respective pieces of data in the first storage medium and the second storage medium are proportional to reciprocals of orders of the access frequencies.

3. The storage device adjusting device according to claim 1, wherein
the processor obtains requirements of a storage device that a user desires and
the interface selects and reports the storage device that has the relatively small difference between the first number of requests and the second number of requests from among the storage devices that satisfy the requirements.

4. A non-transitory computer-readable recording medium having stored therein a tiered storage designing program for causing a processor to execute a process comprising:
obtaining plural pieces of information on a storage device that includes a first storage medium and a second storage medium capable of higher-speed access than the first storage medium;
obtaining ratios of accesses to the respective storage mediums to a total number of accesses for the respective tiered storages, using a function indicating a relationship between pieces of data stored in the respective storage mediums and access frequencies to the respective pieces of data, when pieces of data having high access frequencies have been stored preferentially in the second storage medium;
obtaining a first number of requests that is a number of accesses capable of being processed in the respective tiered storages within a prescribed time period on the basis of a number of requests capable of accessing the first storage medium within the prescribed time period and the ratio for the first storage medium; and
obtaining a second number of requests that is a number of accesses capable of being processed in the respective tiered storages within the prescribed time period on the basis of a number of requests capable of accessing the second storage medium within the prescribed time period and the ratio for the second storage medium; and
preferentially reporting information on the tiered storage device that has a relatively small difference between the first number of requests and the second number of requests.

5. The non-transitory computer-readable recording medium according to claim 4, wherein
the function expresses that magnitudes of the access frequencies to the respective pieces of data in the first storage medium and the second storage medium are proportional to reciprocals of orders of the access frequencies.

6. The non-transitory computer-readable recording medium according to claim 4, wherein the process further comprising:
obtaining requirements of a tired storage that a user desires; and
selecting and reporting the tiered storage that has the relatively small difference between the first number of access requests and the second number of access requests from among the tiered storages that satisfy the requirements.

7. A tiered storage designing method comprising:
obtaining, by a processor, plural pieces of information on a tiered storage that includes a first storage medium and a second storage medium capable of higher-speed access than the first storage medium;
obtaining, by the processor, ratios of accesses to the respective storage mediums to a total number of accesses for the respective tiered storages, using a function indicating a relationship between pieces of data stored in the respective storage mediums and access frequencies to the respective pieces of data, when pieces of data having high access frequencies have been stored preferentially in the second storage medium;
obtaining, by the processor, a first number of requests that is a number of accesses capable of being processed in the respective tiered storages within a prescribed time period on the basis of a number of requests capable of accessing the first storage medium within the prescribed time period and the ratio for the first storage medium; and
obtaining, by the processor, a second number of requests that is a number of accesses capable of being processed in the respective tiered storages within the prescribed time period on the basis of a number of requests capable of accessing the second storage medium within the prescribed time period and the ratio for the second storage medium; and
preferentially reporting, by the processor, information on the tiered storage that has a relatively small difference between the first number of requests and the second number of requests.

8. The tiered storage designing method according to claim 7, wherein
the function expresses that magnitudes of the access frequencies to the respective pieces of data in the first storage medium and the second storage medium are proportional to reciprocals of orders of the access frequencies.

9. The tiered storage designing method according to claim 7, further comprising:
obtaining, by the processor, requirements of a tired storage that a user desires; and
selecting and reporting, by the processor, the tiered storage that has the relatively small difference between the first number of access requests and the second number of access requests from among the tiered storages that satisfy the requirements.
